(19) United States
(12) Patent Application Publication
(10) Pub. No.: US 2010/0330859 A1
(43) Pub. Date: Dec. 30, 2010

(54) METHOD OF CREATING COMPOSITE COMPONENTS WITH A PREFORM WITH HYBRID LAYUP

(75) Inventors: Denis Soula, Toulouse (FR); Sebastien Gohier, La Montagne (FR); Anais Markowski, Toulouse (FR)

Correspondence Address: Perman & Green, LLP, 99 Hawley Lane, Stratford, CT, 06614, US

(73) Assignee: AIRBUS OPERATIONS (S.A.S), (FR)

(21) Appl. No.: 12/745,145

(22) PCT Filed: Nov. 24, 2008
(86) PCT No.: PCT/FR08/52111

§ 371 Date: Sep. 3, 2010

(30) Foreign Application Priority Data
Nov. 28, 2007 (FR) 07 59358

(51) Int. Cl. B32B 5/28; B23P 17/04

(52) U.S. Cl. 442/254; 29/428

(57) ABSTRACT

A method for manufacturing a thin structural component made of composite and intended to withstand, on the one hand, working loads and, on the other hand, accidental loadings. The method involves creating a dry fiber preform of the component that is to be manufactured, and impregnating the aforementioned perform with a matrix-forming resin by resin transfer. The perform is created by assembling at least one structural layer, a first surface reinforcing layer on a first face of the aforementioned structural layer, and a second surface reinforcing layer on a second face of the structural layer. A number of plies in the two surface reinforcing layers is first of all calculated so that the finished component will be able to withstand the accidental loadings, then a number of plies in the structural layer is calculated, with due consideration given to increases in structural strength contributed by the surface reinforcing layers so that the finished component will be able to withstand the working loads.

### CROSS-REFERENCE TO RELATED APPLICATIONS

This application is the National Stage of International Application No. PCT/FR2008/052111 International Filing date, 24 Nov. 2008, which designated the United States of America, and which International Application was published under PCT Article 21 (s) as WO Publication No. WO2009/071824 A2 and which claims priority from, and the benefit of, French Application No. 200759358 filed on 28 Nov. 2007, the disclosures of which are incorporated herein by reference in their entireties.

The aspects of the disclosed embodiments belong to the domain of composite material members manufacturing. More specifically, the aspects of the disclosed embodiments relate to a manufacturing process particularly suited to composite material members in load-bearing aircraft structures.

### BACKGROUND

Composite materials are widely used today for manufacturing members in many industrial domains such as, for instance, aeronautics, including for structural members, i.e. those having to withstand significant forces while in use.

Amongst the existing methods for manufacturing such members, the method of resin transfer molding, also known as RTM, is known.

In known manner, this method comprises a step of creating a reinforcing structure with dry long fibers, called dry preform, with properties and shape suited to the composite material member to be manufactured, a step of impregnating the preform with resin, e.g. thermoplastic or thermosetting, followed by a resin hardening step, e.g. by polymerization. This type of process allows members with complex shapes and the required mechanical properties to be achieved, while still procuring a significant diminution in mass when compared to metal structures.

Currently, the design of composite material structural members using the RTM process, such as a frame 1 of an aircraft fuselage, uses a single dry preform corresponding to the member, as shown in FIG. 1.

Most often, the dry preform is made up of superimposed unidirectional tapes, i.e. in which the fibers making up a given layer are parallel to one another, each tape following different directions depending on the forces the structural member has to withstand. For instance, the tapes are made of glass, carbon or aramid fibers.

This type of dry preform provides the response to the various stresses to which the structural members are subject by favoring the orientation of the fibers in accordance with the forces in the structure, said forces in the structure depending amongst others on the position of the structural member in the structure as well as its mode of loading.

A structural member, such as a fuselage frame, manufactured according to this method is vulnerable however to the following types of stresses:
operational stresses linked to the load generated upon the structure in normal use, e.g. for aircraft, during the different phases of flight, landing, take-off, taxiing, etc.
accidental stresses, such as, for instance, impacts or dents to which the member may be subjected during the manufacturing, transport and assembly phases or during maintenance phases once said structural member is in place on the aircraft, and that may cause local damage, such as delamination, which can propagate throughout the structural member as a result of operational stresses.

To take this disadvantage and the risks related to it into account, the preform and therefore the structural member are oversized so as to guarantee the integrity of the structural member in case of damage, such as delamination, for instance. Such oversizing often causes a significant increase in the mass of the structural member. Further, oversizing of a member causes complications that did not exist when oversizing a metal member. Thus, oversizing can change the behavior of the member in the structure and thus alter its responses. For instance, if the member is significantly stiffened by a resizing, problems will appear during assembly and slight faults, whether of shape or alignment, will bring about significant stresses.

In another process, the dry preform is made of superimposed fabrics comprising woven or braided fibers. This type of preform allows improved resistance to damage to be achieved but since the orientation of the fibers is no longer optimal in this case, it requires the use of more fibers to withstand the forces, also causing an increase in the weight of the structural member.

### SUMMARY

Manufacturing composite material members with increased resistance to damage while retaining structural resistance to operational stresses is therefore important in reducing the members' vulnerability while still helping to reduce the mass of said structural members.

This disclosed embodiments propose to manufacture a composite material member resistant to accidental stresses.

The disclosed embodiments relate to a method for manufacturing a thin composite material structural member designed to withstand, firstly operational stresses corresponding to stresses to which the member is normally subject to in use, and secondly accidental stresses corresponding to external stresses to which the member may exceptionally be subject. The method comprises producing a dry fiber preform of the structural member to be manufactured, achieved essentially by stacking plies, and impregnating said dry fiber preform with a resin matrix. According to the disclosed embodiments, the dry fiber preform is made by assembling at least one load-bearing layer, one first surface reinforcing layer on a first surface of said load-bearing layer and one second surface reinforcing layer, on a second surface opposite said first surface.

According to the disclosed embodiments:

a number of plies in the two surface reinforcing layers is calculated such that the finished structural member withstands accidental stresses,

a number of plies in the load-bearing layer is calculated, taking the contribution of the surface reinforcing layers to the structural resistance into account, such that the finished structural member withstands operational stresses.

The materials used for making the two surface reinforcing layers and the load-bearing tapes are preferably of different kinds so the various layers perform best in their final functions.

Advantageously, the load-bearing layer is made of superimposed unidirectional dry fiber layers and the surface reinforcing layers are made of woven fibers or braided fibers.

In a preferred embodiment, the number of plies in each surface reinforcing layer is chosen such that one thickness of each surface reinforcing layer represents between 10 and 20% of a final thickness of the structural member.

In a particular embodiment, when even further improved resistance is required, plies of external surfaces of the two reinforcing layers are made of woven or braided fibers to which co-woven or co-braided thermoplastic resin threads are mixed.

In another embodiment, a thermoplastic resin sheet is deposited on at least one external surface of the two reinforcing layers before impregnating the preform and thermoplastic resin sheet assembly by transfer of a thermosetting resin matrix.

The disclosed embodiments also relate to a thin composite material structural member achieved by the RTM process that comprises, in its thickness, at the center, a load-bearing core made up essentially of oriented unidirectional fiber plies impregnated with resin and, on either side of the load-bearing core, two protective layers each essentially comprised of at least one ply of resin-impregnated woven fibers.

### BRIEF DESCRIPTION OF THE DRAWINGS

The detailed description of the disclosed embodiments refers to the figures showing, as follows:

FIG. 1, mentioned above, a perspective view of an aircraft fuselage frame according to the previous state of the art,

FIG. 2, an illustration of the various steps in the method,

FIG. 3, an illustration of the various steps of the method according to a particular embodiment of the first step in the method,

FIG. 4, a perspective view of an aircraft fuselage frame according to the disclosed embodiments.

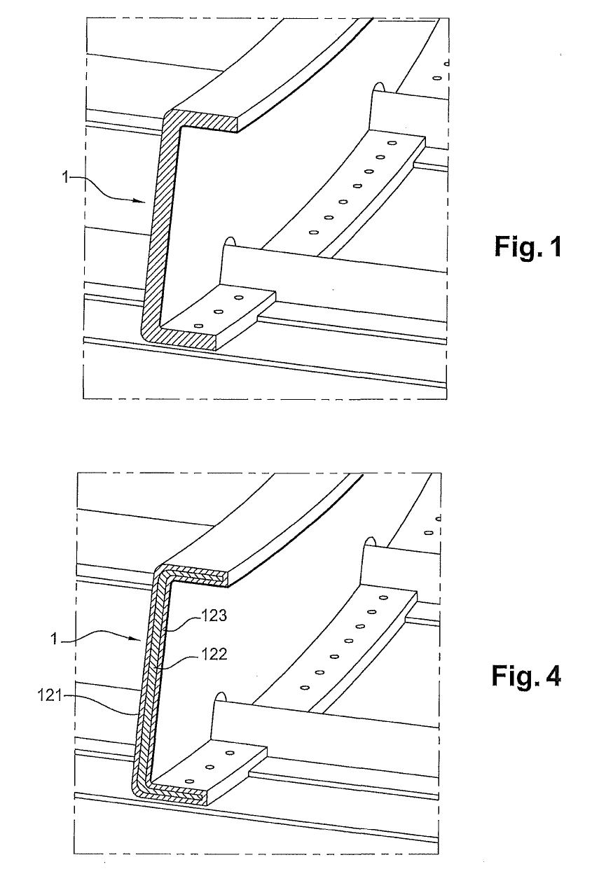

### DETAILED DESCRIPTION

The method according to the disclosed embodiments has the aim of manufacturing a composite material structural member able to withstand operational stresses and to handle the damage-resistance requirements without requiring said structural member to be too oversized in relation to operational stresses.

The implementation example for the method of the disclosed embodiments is described in detail in its application to the case of an aircraft fuselage frame. This choice is not limiting and the method is also applicable to all thin structural members, in particular for aircraft. By “thin structural member” is meant a member, of which one dimension, i.e. the thickness in this case, is small in relation to the other two dimensions.

A composite material frame of fuselage 1, built according a resin transfer method called RTM, comprises essentially a structure made of an assembly of fibers held in resin.

According to the method, in a first step, dry preform 2 is produced.

Preform 2 is made by stacking at least three layers:

a load-bearing layer 22,

a first surface reinforcing layer 21 on a first surface 221 of load-bearing layer 22,

a second surface reinforcing layer 23 on a second surface 221 of load-bearing layer 22, opposite said first surface.

Load-bearing layer 22 and the two surface reinforcing layers 21, 23 are formed with dry fibers.

The properties of surface reinforcing layers 21, 23 are determined from the types of accidental stresses liable to generate internal damages to frame 1 once this last has been built, such that the load-bearing layer located between the two surface reinforcing layers 21, 23 is protected (relatively speaking) from accidental stresses until the outside damage allows the accidental stresses to be detected visually, without requiring in-depth inspections. Said accidental stresses are, for instance, shocks or drilling operations that may cause delamination.

Said surface reinforcing layers comprise at least one ply comprising dry fibers whose type and orientations are determined according to a so-called protection criterion.

The protection criterion implies absorbing shocks and distributing the forces related to the shocks to protect the frame from stress concentration and therefore from delamination.

Advantageously, the two reinforcing layers 21, 23 comprise a ply or superimposed plies made of woven or braided dry fibers, for instance of carbon, glass or aramid.

By their very nature, said surface reinforcing layers contribute their own mechanical resistance that takes part in the structural resistance of the frame.

Load-bearing layer 22 is determined, by calculations according to known design methods, from the stresses to which frame 1 to be manufactured will be subjected. Advantageously, load-bearing layer 22 is determined by taking into account the contribution of the two surface reinforcing layers 21, 23 to structural resistance. Taking the contribution of said two surface reinforcing layers into account avoids oversizing said load-bearing layer and the finished final frame.

Load-bearing layer 22 comprises superimposed plies comprising dry fibers whose type and orientations are determined according to the required mechanical properties of the frame to be built. The calculation of the number of plies and the orientations of fibers in each successive ply is part of known calculation methods applied to thin composite material members.

Advantageously, load-bearing layer 22 comprises superimposed dry fiber plies, e.g. unidirectional tapes or non-woven fabric, called Non-Crimp Fabric or NCF, made of carbon because of the high-level mechanical properties of fibers in this material.

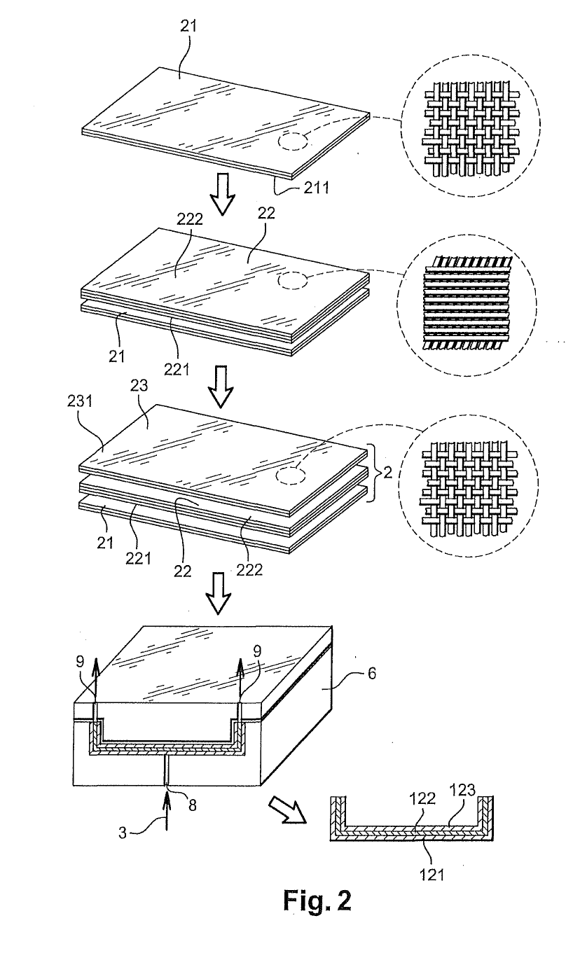

In an embodiment of the first step of the method, the three layers 21, 22, 23 making up preform 2 are made with practically identical surface dimensions and are assembled as shown in FIG. 2, for instance deposited successively, on a form or in a mold to make preform 2.

In a first phase, load-bearing layer 22 is deposited on said first surface reinforcing layer 21 such that first surface 221 of said load-bearing layer 22 covers first surface reinforcing layer 21. In a second phase, second surface reinforcing layer 23 is deposited on said load-bearing layer 22 such that the second surface reinforcing layer covers second surface 222 of said load-bearing layer.

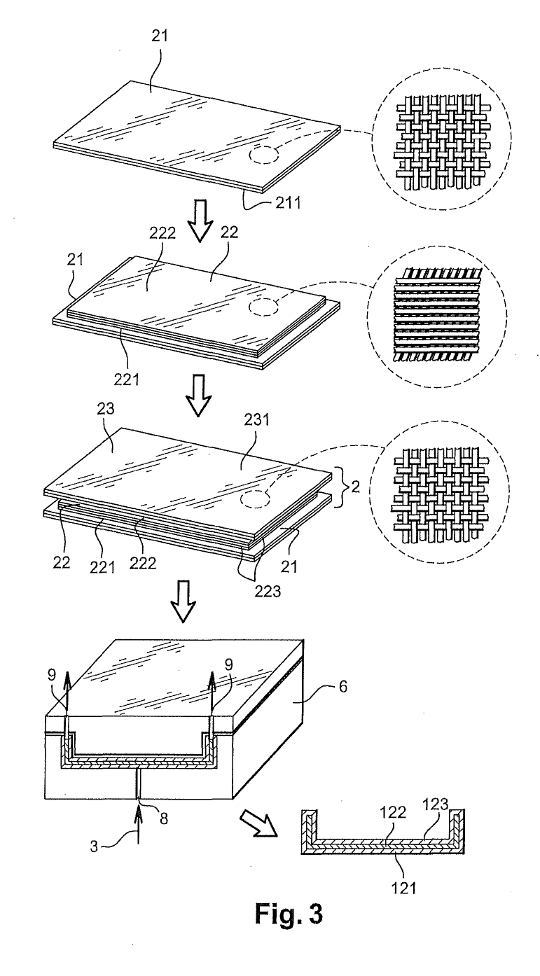

In another embodiment of the first phase of the method, load-bearing layer 22 is made with significantly smaller surface dimensions than those of the two surface reinforcing layers 21, 23, and said three layers are deposited successively as shown in FIG. 3.

In a first phase, first surface 221 of load-bearing layer 22 is deposited on first reinforcing layer 21 such that said first reinforcing layer 21 extends substantially beyond edges 223 of load-bearing layer 22.

In a second phase, second reinforcing layer 23 is deposited on second surface 222 of load-bearing layer 22 so as to completely cover said load-bearing layer and first load-bearing layer 21.

In either mode, as applicable, the layers are assembled, by stitching for instance.

At the end of this first step, preform 2 of frame 1 has been produced and then comprises two surface reinforcing layers 21, 23 covering from either side load-bearing layer 22.

In a second step of the method, preform 2 is impregnated with resin 3, e.g. thermosetting, according to the RTM process.

According to said RTM process, preform 2 is placed inside a mold 6 whose shape and volume practically match the shape and dimensions of the frame to be produced.

Mold 6 comprises at least one inlet opening 8 through which resin 3 is injected and at least one outlet opening 9 through which the air inside the mold is evacuated and through which, in general, excess resin comes out. Resin 3 is injected so as to flow evenly into the internal space bounded by mold 6. More specifically, resin 3 flows into preform 2 by filling the empty areas between the dry fibers of distinct layers 21, 22, 23.

In a third step of the method, the resin is polymerized to join the fibers in the distinct layers.

In the particular embodiment wherein the surface dimensions of load-bearing layer 22 are substantially smaller than the surface dimensions of the two surface reinforcing layers 21, 23, said two surface reinforcing layers also fasten each to the other along edges 221 of load-bearing layer 22 with the result that the frame will also be protected along the edges.

At the end of this third step, frame 3 is demolded and after finishing operations, e.g. drilling or machining passages for elements of the structure, the frame 3 produced is mounted on the structure of which it is part, as shown in FIG. 4.

On exit from the mold, the frame comprises, in its thickness, a load-bearing core 122 and two protection layers 121, 123, said load-bearing core and two protection layers corresponding respectively to fibers 22, 21, 23 of dry preform 2 impregnated with hardened resin.

In preferred embodiments, the thickness of each protection layer is between 10 and 20% of the total thickness of the member in the area in question.

In a particular embodiment, when even further improved resistance to accidental stresses is required, the plies making up the external surfaces 211, 231 of the two surface reinforcing layers 21, 23, opposite faces coupled to load-bearing layer 22, comprise co-woven or co-braided thermoplastic resin threads. The thermoplastic resin of said threads is selected such that the fusion temperature of said resin is significantly lower, equal at most, to the injection temperature of thermosetting resin 3. Thus, in the second step of the utilization of the method, the thermoplastic resin contained in the plies, brought to the temperature of thermosetting resin 3, melts at the time of injection and mixes with thermosetting resin 3 at the external surfaces 211, 231 of the two surface reinforcing layers 21, 23. Since the thermoplastic resin is present in the plies rather than co-injected, it does not modify the viscosity of injected thermosetting resin 3 which impregnates preform 2 more efficiently. Mixing the two resins at the plies of the external surfaces 211, 231 of the two surface reinforcing layers 21, 23, thus allows increased impact resistance and resistance to delamination propagation.

In another embodiment, during the first step of the method, a sheet comprising a thermoplastic resin, with the same properties as the thermoplastic resin threads, is deposited on at least one external surface 211, 231 of one of the two surface reinforcing layers 21, 23. Thus, in the second step in utilizing the method when the thermosetting resin, e.g. epoxy type, is injected, the melting of this sheet brings about the mixing of the thermoplastic and thermosetting resins at the plies of at least one of the external surfaces 211, 231 of the two surface reinforcing surfaces 21, 23 thus giving said plies increased resistance to impacts and delamination.

These embodiments are particularly suited to the manufacture of composite material aircraft frames located in those areas of the fuselage exposed to accidental stresses such as, for example, close to passenger doors or cargo compartment doors.

In a first example of realization, a hybrid layup frame is between 1.6 and 2 mm thick. Load-bearing core 122 is covered by two protection layers, corresponding to woven or braided fibers with orientation of +/−30° and 0.3 mm thickness each. Thus the load-bearing core's thickness is between 1 and 1.4 mm.

To both withstand the load-bearing forces and provide damage resistance, such a frame made entirely with unidirectional fibers would need to be between 1.8 and 2.2 mm thick (instead of 1.6 and 2 mm by using the disclosed embodiments).

In a second example of realization, a hybrid layup frame is between 2.2 and 4 mm thick. The load-bearing core 122 is covered by two protection layers corresponding to woven or braided fibers oriented at 0° and +/−30°, each 0.4 mm thick. Thus the load-bearing core is between 1.4 and 3.2 mm thick.

To both withstand the load-bearing forces and provide damage resistance, such a frame made entirely with unidirectional fibers would need to be between 2.6 and 4.4 mm thick (instead of 2.2 and 4 mm by using the disclosed embodiments).

The disclosed embodiments propose a method allowing the manufacture of a thin composite material member that resists, firstly, the operational forces to which said structural member is subjected, and secondly, accidental stresses, while optimizing the total number of plies in the composite structure and hence its thickness, weight and stiffness.

1. A method for manufacturing a thin composite material structural member designed to resist, firstly, operational stresses corresponding to stresses to which the member is normally subjected in use and, secondly, accidental stresses corresponding to outside stresses to which the member may be exceptionally subjected, said method comprising making a dry fiber preform, obtained essentially by stacking plies, of the structural member to be manufactured, and impregnating said dry fiber preform by resin matrix transfer, wherein the dry fiber preform is made by assembling at least one load-bearing layer, one first surface reinforcing layer on a first surface of said load-bearing layer and one second surface reinforcing layer on a second surface of the load-bearing layer opposite said first surface and wherein:
a number of plies in the two surface reinforcing layers is calculated such that the finished structural member withstands accidental stresses,
a number of plies in load-bearing layer is calculated such that the finished structural member withstands operational stresses, taking the contribution of surface reinforcing layers to the structural resistance into account.

2. A method for manufacturing a composite material structural member according to claim 1 wherein the materials used in making the two surface reinforcing layers and the load-bearing layer are of different kinds.

3. A method for manufacturing a composite material structural member according to claim 1 wherein the load-bearing layer is made up of superimposed unidirectional dry fibers tapes.

4. A method for manufacturing a composite material structural member according to claim 1 wherein the surface reinforcing layers are made of woven fibers.

5. A method for manufacturing a composite material structural member according to claim 1 wherein the surface reinforcing layers are made of braided fibers.

6. A method for manufacturing a composite material structural member according to claim 5 wherein the number of plies in each surface reinforcing layer is selected such that one thickness of each surface reinforcing layer represents between 10 and 20% of the final thickness of the structural member.

7. A method for manufacturing a composite material structural member according to claim 6 wherein plies of external surfaces of the two reinforcing layers are made of woven fibers to which co-woven thermoplastic resin threads are mixed.

8. A method for manufacturing a composite material structural member according to claim 1 wherein plies of external surfaces of the two reinforcing layers are made of braided fibers to which co-braided thermoplastic resin threads are mixed.

9. A method for manufacturing a composite material structural member according to claim 1 wherein a thermoplastic resin sheet is deposited on at least one external face of the two reinforcing layers before impregnating the preform and thermoplastic resin sheet assembly by transfer of a thermosetting resin matrix.

10. A thin composite material member made with the RTM process comprising within its thickness, at the center, a load-bearing core essentially comprised of oriented unidirectional resin fiber plies and, on either side, two protection layers each essentially comprised of at least one ply of woven resin-impregnated fibers.
